(19) United States
(12) Patent Application Publication
(10) Pub. No.: US 2014/0329079 A1
(43) Pub. Date: Nov. 6, 2014

(54) FIRE RESISTANT COMPOSITE STRUCTURE

(71) Applicants: Junqiang Liu, Midland, MI (US); Scott T. Matteucci, Midland, MI (US); Robert C. Clieslinski, Midland, MI (US); Giuseppe Vairo, Correggio (IT); Luigi Bertucelli, Reggio Nell'emilia (IT); David M. Williams, Saginaw, MI (US)

(72) Inventors: Junqiang Liu, Midland, MI (US); Scott T. Matteucci, Midland, MI (US); Robert C. Clieslinski, Midland, MI (US); Giuseppe Vairo, Correggio (IT); Luigi Bertucelli, Reggio Nell'emilia (IT); David M. Williams, Saginaw, MI (US)

(73) Assignee: Dow Global Technologies LLC, Midland, MI (US)

(21) Appl. No.: 14/366,023

(22) PCT Filed: Dec. 27, 2011
(86) PCT No.: PCT/IT2011/000418

§ 371 Date: Jun. 17, 2014

(51) Int. Cl. B32B 5/18; B32B 27/40

(52) U.S. Cl. CPC B32B 5/18; B32B 27/40; B32B 2266/0278; B32B 2255/205; B32B 2307/3065
USPC 428/317.1

(57) ABSTRACT

The present invention relates to fire resistant composite structures. As an example, a fire resistant composite structure can have a foam material located between a first facing and a second facing, and a barrier layer on the foam material. The barrier layer can include an adhesive material and a heat absorption material, where the heat absorption material has a melting point of 40° C. to 140° C. and is 15 weight percent to 99 weight percent of the barrier layer.

### FIELD OF DISCLOSURE

The present disclosure relates generally to fire resistant composite structures, and more particularly to fire resistant composite structures having a foam material and a barrier layer.

### BACKGROUND

Structural insulating panels are a composite building material. Structural insulating panels include an insulating layer of rigid foam sandwiched between two layers of a structural board. The structural board can be organic and/or inorganic. For example, the structural board can be a metal, metal alloy, gypsum, plywood, and combinations thereof, among other types of board.

Structural insulating panels many be used in variety of different applications, such as walling, roofing, and/or flooring. Structural insulating panels may be utilized in commercial buildings, residential buildings, and/or freight containers, for example.

Structural insulating panels may help to increase energy efficiency of buildings and/or containers utilizing the panels, as compared to other buildings or containers that do not employ structural insulating panels.

Structural insulating panels have desirable stability and durability properties. For example, structural insulating panels can last throughout the useful lifetime of the building or container employing the panels. Thereafter, the panels can be reused or recycled.

### SUMMARY

The present disclosure provide a fire resistant composite structure having a foam material located between a first facing and a second facing, and a barrier layer on the foam material. The barrier layer includes an adhesive material and a heat absorption material, wherein the heat absorption material has a melting point of 40° C. to 140° C. and is 15 weight percent to 99 weight percent of the barrier layer.

The present disclosure provide a fire resistant composite structure having a foam material located between a first facing and a second facing, and a barrier layer on the foam material. The barrier layer includes an adhesive material and a heat absorption material, where the heat absorption material has a reflective coating, a melting point of 40° C. to 140° C. and is 15 weight percent to 99 weight percent of the barrier layer.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1A illustrates of a portion of a fire resistant composite structure in accordance a number of embodiments of the present disclosure.

FIG. 1B is cross-sectional view of FIG. 1A taken along cut line 1A-1A of FIG. 1A.

FIG. 2 is cross-sectional view of a fire resistant composite structure in accordance a number of embodiments of the present disclosure.

FIG. 3 is cross-sectional view of a fire resistant composite structure in accordance a number of embodiments of the present disclosure.

FIG. 4 is cross-sectional view of a fire resistant composite structure in accordance a number of embodiments of the present disclosure.

FIG. 5 is cross-sectional view of a fire resistant composite structure in accordance a number of embodiments of the present disclosure.

FIG. 6A illustrates experimental temperature versus time data.

FIG. 6B illustrates experimental temperature versus time data.

FIG. 6C illustrates experimental temperature versus time data.

FIG. 6D illustrates experimental temperature versus time data.

### DETAILED DESCRIPTION

Fire resistant composite structures having a foam material located between a first facing and a second facing and a barrier layer on the foam material, where the barrier layer includes an adhesive material and a heat absorption material, where the heat absorption material has a melting point of 40° C. to 140° C. and is 15 weight percent to 99 weight percent of the barrier layer are described herein.

Embodiments of the present disclosure can provide increased fire resistance as compared to previous panel approaches, such as panels not having a barrier layer on the foam material. The barrier layer can include an adhesive material and a heat absorption material. The heat absorption material can absorb heat to help protect the foam material and provide the fire resistant composite structure with an increased fire resistance. The heat absorption material can absorb heat via a latent heat event, e.g., melting and/or another phase change, for example.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure.

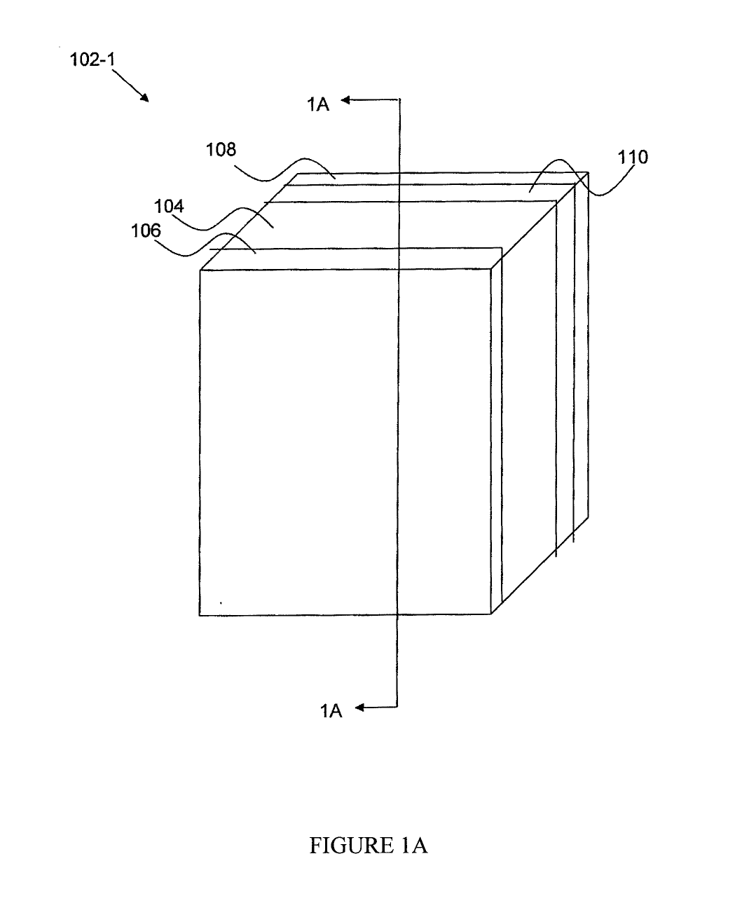

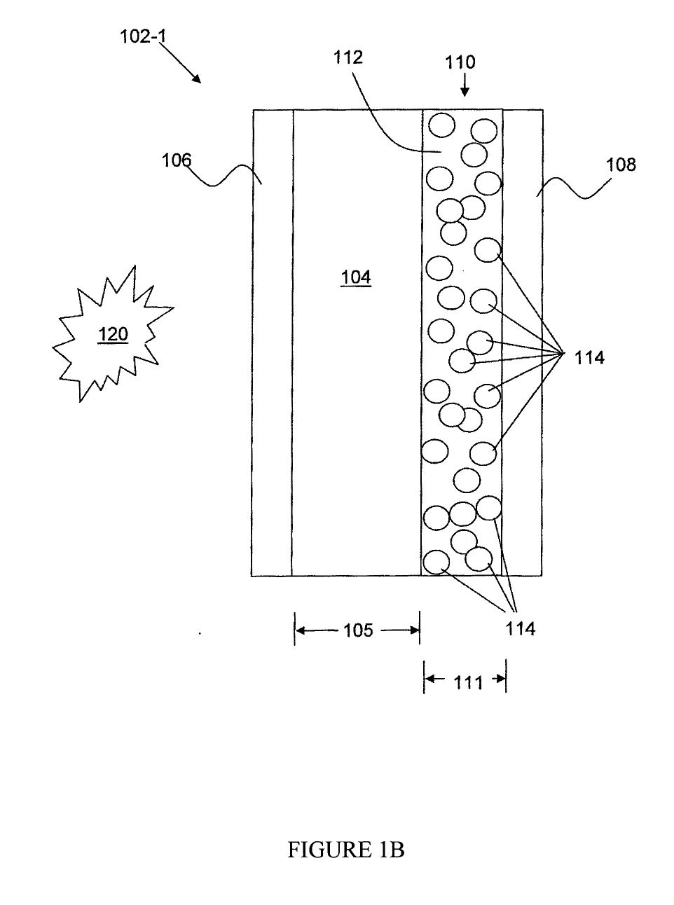

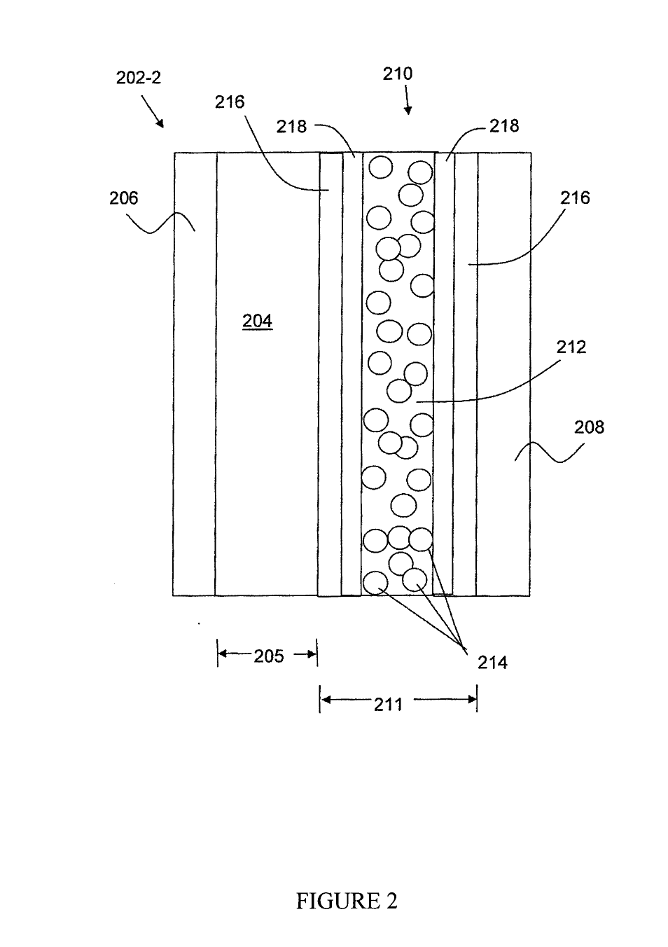

The figures herein follow a numbering convention in which the first digit or digits correspond to the drawing figure number and the remaining digits identify an element or component in the drawing. Similar elements or components between different figures may be identified by the use of similar digits. For example, 104 may reference element “4” in FIG. 1, and a similar element may be referenced as 204 in FIG. 2. An element including an associated digit may also be referred to without reference to a specific figure. For example, “element 4” may be referenced in the description without reference to a specific figure.

FIG. 1A illustrates of a portion of a fire resistant composite structure 102-1 in accordance a number of embodiments of the present disclosure. For various applications, the fire resistant composite structures, as disclosed herein, may be referred to as sandwich panels, structural insulating panels or self-supporting insulating panels, among other references. The fire resistant composite structures, as disclosed herein, may be formed by a variety of processes. For example, the fire resistant composite structures may be formed by a continuous process, such as a continuous lamination process employing a double belt/band arrangement wherein components of a barrier layer can be deposited, e.g., poured or sprayed, onto a first facing surface, which may be flexible or rigid; then, a reaction mixture for forming a foam material can be deposited, e.g., poured or sprayed, onto the barrier layer; the components of a second barrier layer, when present, can be deposited, e.g., poured or sprayed, onto the reaction mixture for forming the foam material, or the foam material if curing of the reaction mixture has occurred; then an second facing surface can be contacted with the second barrier layer, the reaction mixture for forming the foam material, or the foam material. For various applications other formation processes may be employed. For example, the components of a second barrier layer, when present, can be deposited, e.g., poured or sprayed, onto a surface of the second facing. Additionally, the fire resistant composite structures, as disclosed herein, may be formed by a discontinuous process including depositing, e.g., pouring or spraying, the components of a barrier layer on the first facing and/or the second facing. Then the first and second facings may be placed in a press and a reaction mixture for forming a foam material can be deposited, e.g., poured or injected, between the first and second facings.

The fire resistant composite structure 102-1 is a composite building material that may be utilized for a variety of applications. The fire resistant composite structure 102-1 includes a foam material 104 located between a first facing 106 and a second facing 108. The fire resistant composite structure 102-1 includes a barrier layer 110.

The foam material 104 may be thermoset foam, e.g. a polymer foam that has been formed by an irreversible reaction to a cured state. The foam material 104 may be a polyisocyanurate foam, a polyurethane foam, a phenoic foam, and combinations thereof, among other thermoset foams. As an example, the foam material 104 may be a rigid polyurethane/polyisocyanurate (PU/PIR) foam. Polyisocyanurate foams can be formed by reacting a polyol, e.g., a polyester glycol, and an isocyanate, e.g., methylene diphenyl diisocyanate and/or poly(methylene diphenyl diisocyanate), where the number of equivalents of isocyanate groups is greater than that of isocyanate reactive groups and stoichiometric excess is converted to isocyanurate bonds, for example, the ratio may be greater than 1.8. Polyurethane foams can be formed by reacting a polyol, e.g., a polyester polyol or a polyether polyol, and an isocyanate, e.g., methylene diphenyl diisocyanate and/or poly(methylene diphenyl diisocyanate), where the ratio of equivalents of isocyanate groups to that of isocyanate reactive groups is less than 1.8. Phenolic foams can be formed by reacting a phenol, e.g., carboxylic acid, and an aldehyde, e.g., formaldehyde. Forming the foam material 104 may also include employing a blowing agent, a surfactant, and/or a catalyst.

FIG. 1B is cross-sectional view of FIG. 1A taken along cut line 1A-1A of FIG. 1A. As illustrated in FIG. 1B, the foam material is located between the first facing 106 and the second facing 108 of fire resistant composite structure 102-1. The first facing 106 and the second facing 108 may be a suitable material for composite building materials. For example, in accordance with a number of embodiments of the present disclosure the first facing 106 and the second facing 108 can each independently be formed from aluminium, steel, stainless steel, copper, glass fiber-reinforced plastic, gypsum, or a combination thereof, among other materials. The first facing 106 and the second facing 108 can each independently have a thickness of 0.05 millimeters to 25.00 millimeters. All individual values and subranges from 0.05 millimeters to 25.00 millimeters are included herein and disclosed herein; for example, the first facing 106 and the second facing 108 can each independently have a thickness from an upper limit of 25.00 millimeters, 20.00 millimeters, or 15.00 millimeters to a lower limit of 0.05 millimeters, 0.10 millimeters, or 0.20 millimeters. For example, the first facing 106 and the second facing 108 can each independently have a thickness of 0.05 millimeters to 25.00 millimeters, 0.10 millimeters to 20.00 millimeters, or 15.00 millimeters to 0.20 millimeters.

The foam material 104 can have a thickness 105 of 40 millimeters to 300 millimeters. All individual values and subranges from 40 millimeters to 300 millimeters are included herein and disclosed herein; for example, the foam material can have a thickness from an upper limit of 300 millimeters, 250 millimeters, or 200 millimeters to a lower limit of 40 millimeters, 45 millimeters, or 50 millimeters. For example, the foam material can have a thickness of 40 millimeters to 300 millimeters, 45 millimeters to 250 millimeters, or 50 millimeters to 200 millimeters.

In accordance with a number of embodiments of the present disclosure, the fire resistant composite structure 102-1 includes the barrier layer 110 on the foam material 104. The barrier layer 110 can include components such as an adhesive material 112 and a heat absorption material 114. Components of the barrier layer 110, e.g., 112, 114, total one hundred weight percent of the barrier layer 100.

The adhesive material 112 can include a crosslinking adhesive, such as a thermoset adhesive. For example, the adhesive material 112 can include a polyisocyanurate, a urethane, e.g., a urethane glue, an epoxy system, or a sulfonated polystyrene, among other thermoset adhesives. In accordance with a number of embodiments of the present disclosure, the adhesive material 112 binds the heat absorption material 114 to form the barrier layer 110. For example, the adhesive material 112 may suspend and/or support the heat absorption material 114 throughout the barrier layer 110.

The adhesive material 112 can be from 1 weight percent to 85 weight percent of the barrier layer 110. All individual values and subranges from 1 weight percent to 85 weight percent are included herein and disclosed herein; for example, the adhesive material can be from an upper limit of 85 weight percent, 80 weight percent, or 75 weight percent of the barrier layer to a lower limit of 1 weight percent, 10 weight percent, or 15 weight percent of the barrier layer, where the weight percents are based upon a total weight of the barrier layer. For example, the adhesive material can be from 1 weight percent to 85 weight percent of the barrier layer, from 10 weight percent to 80 weight percent of the barrier layer, or from 15 weight percent to 75 weight percent of the barrier layer, where the weight percents are based upon a total weight of the barrier layer.

As discussed herein, the fire resistant composite structure 102-1 includes heat absorption material 114 that can absorb heat via a latent heat event, e.g., melting, to help protect the foam material 104 and/or provide the fire resistant composite structure 102-1 with an increased fire resistance. Additionally, in accordance with a number of embodiments of the present disclosure, heat may be absorbed via decomposition of the heat absorption material 114. For example, during decomposition of the heat absorption material 114 water can be released from the heat absorption material 114 and the released water cab absorb heat to help protect the foam material 104 and/or provide the fire resistant composite structure 102-1 with an increased fire resistance.

The heat absorption material 114 can have a melting point of 40 degrees Celsius (° C.) to 140° C. All individual values and subranges from 40° C. to 140° C. are included herein and disclosed herein; for example, heat absorption material can have a melting point from an upper limit of 140° C., 138° C., or 135° C. to a lower limit of 40° C., 50° C., or 60° C. For example, the heat absorption material can have a melting point of 40° C. to 140° C., of 50° C. to 138° C., or of 60° C. to 135° C.

Having a melting point of 40° C. to 140° C. can help protect the foam material 104 and provide the fire resistant composite structure 102-1 with an increased fire resistance. As an example, fire resistance can be determined by testing for a fire resistance failure mechanism. For example, the testing can include, a first fire resistance failure mechanism that occurs when an average temperature on an unexposed side, e.g., a surface of the foam material or an outer skin, of a tested panel reaches a temperature greater than 140° C. and/or a second fire resistance failure mechanism that occurs when a temperature location on an unexposed side, e.g., a surface of the foam material or any an skin, of a tested panel reaches a temperature greater than 180° C., e.g. due to crack generation in the panel and heat conduction associated with the crack. Having the melting point of 40° C. to 140° C. can help provide that heat absorption via melting and/or decomposition of the heat absorbing material occurs prior to fire resistance failure, thus resulting in an increased fire resistance. Achieving a lower temperature on a portion of the fire resistant composite structure, as compared to a temperature on another structure, under similar heating conditions can be considered an improved fire resistance.

The heat absorption material 114 can be selected from the group consisting of a hydrated salt, a polyol, a paraffin, high density polyethylene, and combinations thereof. Examples of the hydrated salt include, but are not limited to, potassium fluoride dihydrate, potassium acetate hydrate, potassium phosphate heptahydrate, zinc nitrate tetrahydrate, calcium nitrate tetrahydrate, disodium phosphate heptahydrate, sodium thiosulfate pentahydrate, zinc nitrate dihydrate, sodium hydroxide monohydrate, sodium acetate trihydrate, cadmium nitrate tetrahydrate, ferric nitrate hexahydrate, sodium hydroxide, sodium tetraborate decahydrate, trisodium phosphate dodecahydrate, sodium pyrophosphate decahydrate, barium hydroxide octahydrate, aluminium potassium sulfate dodecahydrate, aluminium sulfate octadecahydrate, magnesium nitrate hexahydrate, ammonium aluminium sulfate hexahydrate, sodium sulfide hydrate, calcium bromide tetrahydrate, aluminium sulfate hexadecahydrate, magnesium chloride hexahydrate, aluminium nitrate nonahydrate, lithium acetate dihydrate, strontium hydroxide octahydrate, lithium chloride hydrate, aluminium hydroxide hydrate, calcium sulfate hydrate, and combinations thereof. The polyol can be a glycol or a sugar alcohol, for example. Examples of glycols include, but are not limited to polyethylene glycols and methoxypolyethylene glycol. An example of the sugar alcohol includes, but is not limited to, ((2R,3S)-butane-1,2,3,4-tetraol), which may also be refereed to as erythritol. Examples of the paraffin include, but are not limited to, paraffins having from 21 to 50 carbon atoms and a formula of CₙH₂ₙ₊₂, e.g., linear chain hydrocarbons, such as n-hexadecane, n-heptadecane, n-cotadecane, n-eicosane, n-heneicosane, among other paraffins. The high density polyethylene can have a density of 0.93 grams/cm³ to 0.97 grams/cm³.

The heat absorption material 114 can be from 15 weight percent to 99 weight percent of the barrier layer 110. All individual values and subranges from 15 weight percent water to 99 weight percent are included herein and disclosed herein; for example, the heat absorption material can be from an upper limit of 99 weight percent, 90 weight percent, or 85 weight percent of the barrier layer to a lower limit of 15 weight percent, 20 weight percent, or 25 weight percent of the barrier layer, where the weight percents are based upon a total weight of the barrier layer. For example, the heat absorption material can be from 15 weight percent to 99 weight percent of the barrier layer, from 20 weight percent to 90 weight percent of the barrier layer, or from 25 weight percent to 85 weight percent of the barrier layer, where the weight percents are based upon a total weight of the barrier layer.

The heat absorption material 114 can be particulate, e.g., separate and distinct particles. The heat absorption material 114 of the present disclosure may be of differing sizes and/or shapes for various applications. For example, in accordance with a number of embodiments of the present disclosure, the heat absorption material 114 can be substantially spherical. However, embodiments are not so limited. In accordance with a number of embodiments of the present disclosure, the heat absorption material 114 can be substantially non-spherical. Examples of substantially non-spherical shapes include, but are not limited to, cubic shapes, polygonal shapes, elongate shapes, and combinations thereof.

As illustrated in FIG. 1B, the barrier layer 110 is adjacent, e.g., on, the foam material 104 and the second facing 108, where the adhesive material 112 can bond the barrier layer 110 to the foam material 104 and/or the second facing 108. However, as discussed herein embodiments are not so limited.

FIG. 2 is cross-sectional view of a fire resistant composite structure 202-2 in accordance a number of embodiments of the present disclosure. As shown in FIG. 2, the barrier layer 210 may include a sealing adhesive material 216. The sealing adhesive material 216 may encapsulate the first adhesive material 212 and the heat absorption material 214 such that the sealing adhesive material bonds the barrier layer 210 to the foam material 204, for example. The sealing adhesive material can be an adhesive material as discussed herein.

The sealing adhesive material 216 can be from 1 weight percent to 30 weight percent of the barrier layer 210. All individual values and subranges from 1 weight percent water to 30 weight percent are included herein and disclosed herein; for example, the sealing adhesive material 216 can be from an upper limit of 30 weight percent, 25 weight percent, or 20 weight percent of the barrier layer 210 to a lower limit of 1 weight percent, 2 weight percent, or 3 weight percent of the barrier layer 210, where the weight percents are based upon a total weight of the barrier layer 210. For example, the sealing adhesive material 216 can be from 1 weight percent to 30 weight percent of the barrier layer 210, from 2 weight percent to 25 weight percent of the barrier layer 210, or from 3 weight percent to 20 weight percent of the barrier layer 210, where the weight percents are based upon a total weight of the barrier layer 210.

As shown in FIG. 2, the barrier layer 210 may include a lining material 218. As shown in FIG. 2, the lining material 218 may separate the first adhesive material 212 and the sealing adhesive material 216. For example, the lining material 218 can encapsulate the first adhesive material 212. A variety of lining materials may be applicable for differing applications. For example, the lining material may be a foil, such as an aluminium foil, among other lining materials.

The barrier layer 10 can have a thickness 11 of 2 millimeters to 100 millimeters. All individual values and subranges from 2 millimeters to 100 millimeters are included herein and disclosed herein; for example, the barrier layer 10 can have a thickness 11 from an upper limit of 100 millimeters, 80 millimeters, or 60 millimeters to a lower limit of 2 millimeters, 3 millimeters, or 5 millimeters. For example, the barrier layer 10 can have a thickness 11 of 2 millimeters to 100 millimeters, 3 millimeters to 80 millimeters, or 5 millimeters to 60 millimeters.

Referring again to FIG. 1B, in accordance with a number of embodiments of the present disclosure, the first facing 106 can be configured to face a heat source 120, e.g., a fire, among other heat sources. Further, in accordance with a number of embodiments of the present disclosure, the barrier layer 110 can be adjacent the second facing 108. In this example, heat can travel from heat source 120 to foam material 104 to barrier layer 110. Locating the barrier layer 110 behind the foam layer 104, relative to heat source 120 and/or the first facing 106 configured to face the heat source 120 may help to provide a desirable effectiveness of the barrier layer 110 to help protect the foam material 104 and/or provide the fire resistant composite structure 102-1 with an increased fire resistance. For example, locating the barrier layer 110 behind the foam layer 104, relative to heat source 120 and/or the first facing 106 configured to face the heat source 120, may help provide that heat absorption, e.g., via a latent heat event, is prolonged by a reduced temperature gradient relative to a temperature gradient located nearer to the heat source 120.

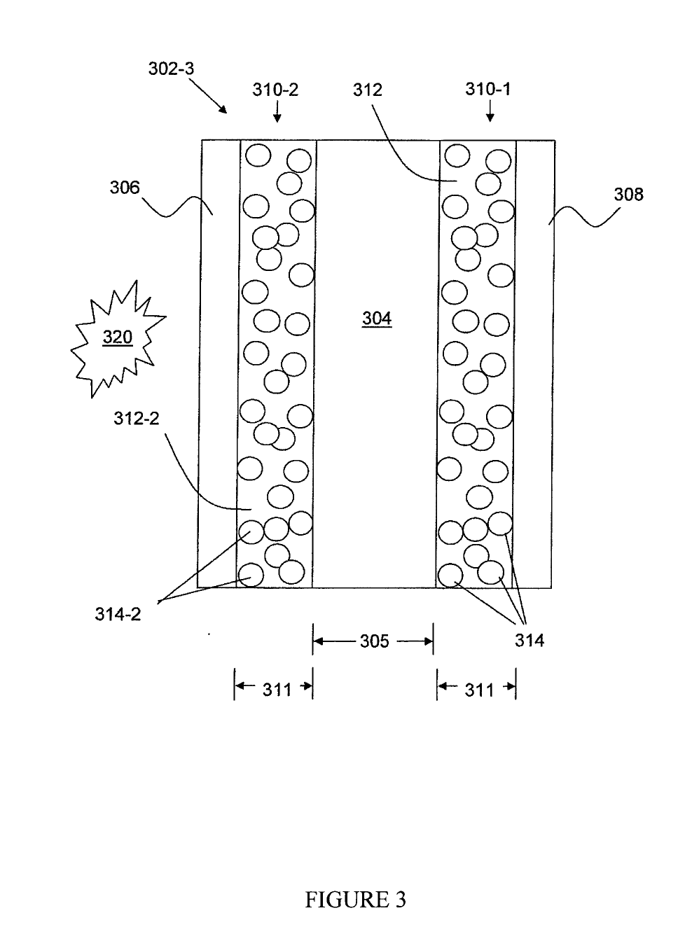

FIG. 3 is cross-sectional view of a fire resistant composite structure 302-3 in accordance a number of embodiments of the present disclosure. As shown in FIG. 3, the fire resistant composite structure 302-3 can include more than one barrier layer 10, e.g., barrier layer 310-1 and a second barrier layer 310-2 on the foam material 304. The second barrier layer 310-2 can have similar properties as the first barrier layer as described herein. For example, the second barrier layer 310-2 can include a second adhesive material 312-2 and a second heat absorption material 314-2, where the second adhesive material 312-2 can have similar properties as the first adhesive material 312 and the second heat absorption material 314-2 can have similar properties as the first heat absorption material 314, each as respectively described herein. As shown in FIG. 3, the second barrier layer 310-2 can be on the foam material 304 and adjacent the first facing 306. For example, the second barrier layer 310-2 can be on the foam material 304 opposite of the first barrier layer 310-1. The second barrier layer 310-2 can further help protect the foam material 304 and provide the composite structure 302-3 with an increased fire resistance.

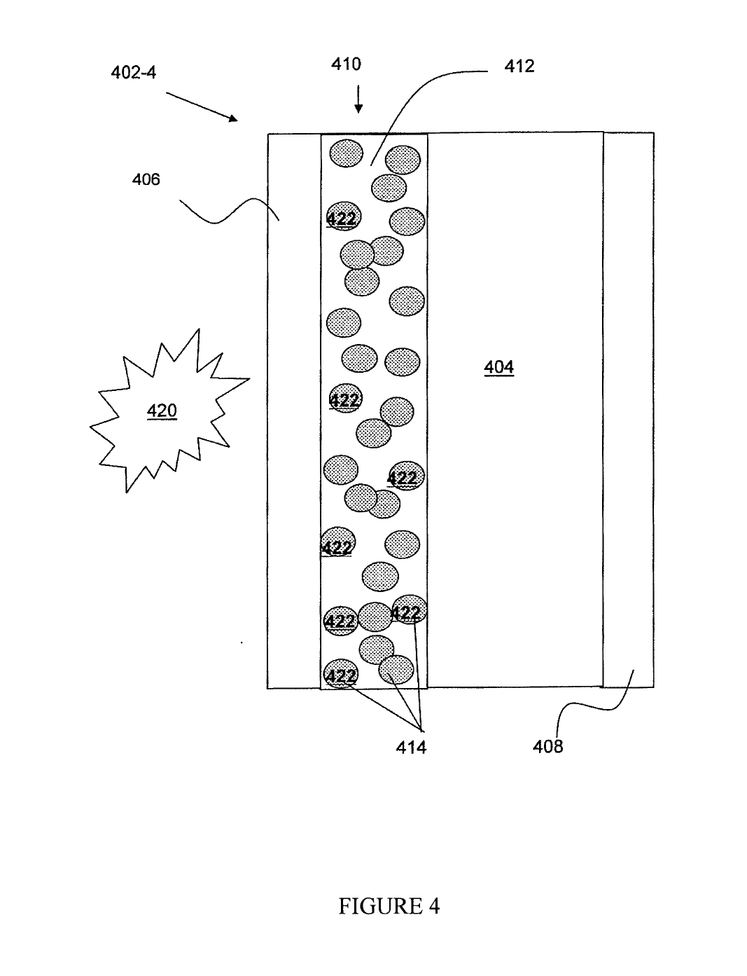

FIG. 4 is cross-sectional view of a fire resistant composite structure 402-4 in accordance a number of embodiments of the present disclosure. In the example illustrated in FIG. 4, the heat absorption material 414 includes a reflective coating 422. The reflective coating 422 can be a paint such as an oil based paint or an epoxy powder paint, among other reflective coatings. The reflective coating 422 can reflect thermal heat, e.g. in an infrared (IR) band and/or in a near infrared (NIR) band, to help protect foam material 404 and provide the composite structure 402-4 with an increased fire resistance. The reflective coating 422 can include a reflective material such as a metal, e.g., aluminium or silver, or glass, among other reflective materials. The reflective coating 422 may be applied to the heat absorption material 414 by a variety of processes including, but not limited to, tumble coating, spray coating, and roll coating. Separate and distinct particles of the heat adsorption material 414 may each be completely coated with the reflective coating 422. However, embodiments are not so limited. For example, separate and distinct particles of the heat adsorption material 414 may be partially coated with the reflective coating 422.

As discussed, the first facing 06 can be configured to face a heat source 20. As illustrated in FIG. 4, the barrier layer 410, including the heat absorption material 414 having the reflective coating 422, can be adjacent the first facing 406. In this example, heat can travel from heat source 420 to barrier layer 410, where a portion of the heat may be reflected by the reflective coating 422 on heat absorption material 414. Further advantageously, the reflective coating 422 help to maintain heat absorption material 414, e.g., so that heat absorption material 414 does not prematurely melt or prematurely release water either in response to heat transfer from heat source 420 or from heat generated via curing of the adhesive material 412, e.g., during application of the barrier layer 410 and/or the foam material 404.

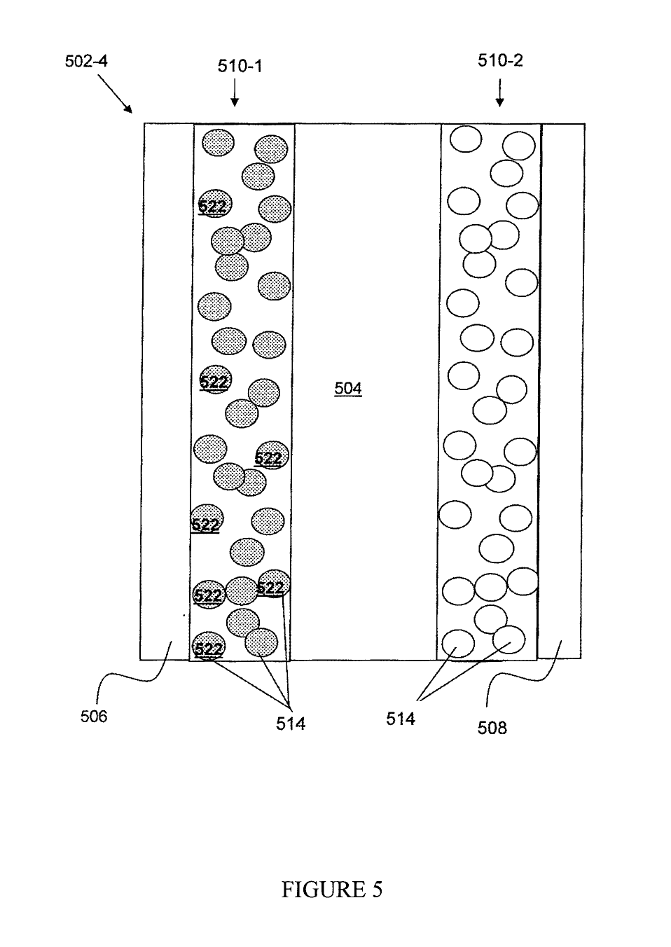

FIG. 5 is cross-sectional view of a fire resistant composite structure in accordance a number of embodiments of the present disclosure. As shown in FIG. 5, the fire resistant composite structure 502-4 can include more than one barrier layer 10, e.g., barrier layer 310-1 where the heat absorption material 514 includes the reflective coating 522 and a second barrier layer 510-2 on the foam material 504. The second barrier can be on foam material 504 and adjacent the second facing 508.

In accordance with a number of embodiments of the present disclosure, a barrier layer 10 as disclosed herein may include an additional component, such as a hollow silicate material. Examples of hollow silicate materials include, but are not limited to glass spheres, aerogels, cenospheres, zeolites, mesoporous silicate structures, and combinations thereof. Aerogels include low density silicate structures produced by a sol-gel process. Cenospheres include hollow glass spheres. The hollow glass spheres may include an additive, such as alumina, for example. Zeolites include natural and synthetic alumina/silicates, for example, and may contain a metal cation. Mesoporous silicate structures include structures obtained by forming silica around an organic template that can be removed after the silica forms.

The additional component can have a bulk density that is less than 1.0 gram per cubic centimeter (g/cm³). For example, the additional component can have a bulk density that is less than 0.5 g/cm³. For some applications the additional component can have a bulk density that is less than 0.2 g/cm³.

The additional component can be from 1 weight percent to 50 weight percent of the barrier layer 10. All individual values and subranges from 1 weight percent water to 50 weight percent are included herein and disclosed herein; for example, the additional component can be from an upper limit of 50 weight percent, 40 weight percent, or 30 weight percent of the barrier layer 10 to a lower limit of 1 weight percent, 2 weight percent, or 3 weight percent of the barrier layer 10, where the weight percents are based upon a total weight of the barrier layer 10. For example, the additional component can be from 1 weight percent to 50 weight percent of the barrier layer 10, from 2 weight percent to 40 weight percent of the barrier layer 10, or from 3 weight percent to 30 weight percent of the barrier layer 10, where the weight percents are based upon a total weight of the barrier layer 10.

The above description has been made in an illustrative fashion, and not a restrictive one. The scope of the various embodiments of the present disclosure includes other applications and/or components that will be apparent to those of skill in the art upon reviewing the above description.

### EXAMPLES

All heat absorbent materials employed herein are available from Sigma Aldrich® unless otherwise noted.

### Examples 1-4

Fire resistant composite structures, Examples 1-4, were fabricated as follows. Heat absorbent material and adhesive material were thoroughly mixed, applied to a foam material, and cured to provide a barrier layer of a desired thickness. For Examples 1-4 a 0.3 millimeter thick steel plate was attached to the foam material on the opposite side of the barrier layer with a non-foaming polyurethane (FoamFast 74 available from 3M™) that was employed to facilitate experimental procedures and was not a component of a barrier layer. For Examples 1-4 the foam material was a polyisocyanurate foam (made with VORATHERM™ CN604 polyisocyanurate system, available from The Dow Chemical Company). For Examples 1-3 the adhesive material was an epoxy system (Loctite® Epoxy Quick Set™ available from Henkel Corporation). For Example 4 the adhesive material was a polystyrene having an average molecular weight of 1,000,000 (available from Sigma Aldrich®). Data in Table 1 indicates properties of Examples 1-4.

TABLE 1

| | | Weight | Weight | | |
|---|---|---|---|---|---|
| | | percentage of | percentage | | Foam |
| | Heat | heat absorption | of adhesive | Barrier layer | material |
| | absorption | material in | material in | thickness | thickness |
| | material | barrier layer | barrier layer | (millimeters) | (millimeters) |
| Example 1 | Barium | 50 | 50 | 5 | 80 |
| | hydroxide | | | | |
| | octahydrate | | | | |
| | (Ba(OH)₂•8H₂O) | | | | |
| Example 2 | Disodium | 50 | 50 | 5 | 80 |
| | phosphate | | | | |
| | heptahydrate | | | | |
| | (Na₂HPO₄•7H₂O) | | | | |
| Example 3 | Barium | 50 | 50 | 5 | 100 |
| | hydroxide | | | | |
| | octahydrate | | | | |
| | (Ba(OH)₂•8H₂O) | | | | |
| Example 4 | Aluminium | 67 | 33 | 15 | 100 |
| | hydroxide | | | | |
| | hydrate | | | | |
| | (Al(OH)₃•xH₂O) | | | | |

### Examples 5-6

Fire resistant composite structures, Examples 5-6, were fabricated as follows. For Example 5 heat absorbent material was tumble coated with a reflective coating of aluminium oil based paint (Rust Stop oil base enamel 225A110 Metallic Aluminium available from Ace Paint), where the paint was 1 to 4 weight percent based upon a total weight of the heat absorbent material. For Example 6 heat absorbent material was tumble coated with a reflective coating of aluminium epoxy power paint (Aluminium Powder Coating available from Eastwood). The reflective coated heat absorbent materials were each mixed with a respective adhesive material, applied to a foam material, and cured to provide a barrier layer of a desired thickness. For examples 5-6 a 0.3 millimeter thick steel plate was attached to the barrier layer with a non-foaming polyurethane (FoamFast 74 available from 3M™) that was employed to facilitate experimental procedures and was not a component of a barrier layer. For Examples 5-6 the foam material was a polyisocyanurate foam (made with VORATHERM™ CN604 polyisocyanurate system, available from The Dow Chemical Company). For Examples 5-6 the adhesive material was an epoxy system (Loctite® Epoxy Quick Set™ available from Henkel Corporation). Data in Table 2 indicates properties of Examples 5-6.

TABLE 2

| | | Weight | Weight | | |
|---|---|---|---|---|---|
| | | percentage of | percentage | | Foam |
| | Heat | heat absorption | of adhesive | Barrier layer | material |
| | absorption | material in | material in | thickness | thickness |
| | material | barrier layer | barrier layer | (millimeters) | (millimeters) |
| Example 5 | Disodium | 70 | 30 | 10 | 100 |
| | phosphate | | | | |
| | heptahydrate | | | | |
| | (Na₂HPO₄•7H₂O) | | | | |
| Example 6 | Disodium | 70 | 30 | 10 | 100 |
| | phosphate | | | | |
| | heptahydrate | | | | |
| | (Na₂HPO₄•7H₂O) | | | | |

### Example 7

Fire resistant composite structure, Example 7, was fabricated as follows. Heat absorbent material and adhesive material were mixed, applied to a foam material, and cured to provide a barrier layer of a desired thickness. For Example 7a 0.3 millimeter thick steel plate was attached to the foam material on the opposite side of the barrier layer with a non-foaming polyurethane (FoamFast 74 available from 3M™) that was employed to facilitate experimental procedures and was not a component of a barrier layer. For Example 7 the foam material was a polyisocyanurate foam (made with VORATHERM™ CN604 polyisocyanurate system, available from The Dow Chemical Company). For Example 7 the adhesive material was an epoxy system including 5 parts EPDXICURE® epoxy resin (available from Buehler, Ltd.) and 1 part EPDXICURE® hardener (available from Buehler Ltd.). Data in Table 3 indicates properties of Example 7.

TABLE 3

| | | Weight | Weight | | |
|---|---|---|---|---|---|
| | | percentage of | percentage | | Foam |
| | Heat | heat absorption | of adhesive | Barrier layer | material |
| | absorption | material in | material in | thickness | thickness |
| | material | barrier layer | barrier layer | (millimeters) | (millimeters) |
| Example 7 | Polyol | 50 | 50 | 4 | 76 |
| | ((2R,3S)-butane- | | | | |
| | 1,2,3,4-tetraol) | | | | |

### Comparative Examples A-C

Comparative Examples A-C, were fabricated as follows. A 0.3 millimeter thick steel plate was attached to a respective polyisocyanurate foam (made with VORATHERM™ CN604 polyisocyanurate system, available from The Dow Chemical Company) with a non-foaming polyurethane (FoamFast 74 available from 3M™) that was employed to facilitate experimental procedures and was not a component of a barrier layer for each of Comparative Examples A-C. For Comparative Example A the polyisocyanurate foam had a thickness of 80 millimeters. For Comparative Example B the polyisocyanurate foam had a thickness of 100 millimeters. For Comparative Example C the polyisocyanurate foam had a thickness of 76 millimeters.

Fire resistance of Examples 1-7 and Comparative Examples A-B was tested as follows. A 76.2 millimeter by 76.2 millimeter hole was formed in the door of a Thermolyne FD 1535M furnace. The furnace is heated to provide a temperature versus time curve in accordance to the one used in EN 1361-1 testing standard, which is the same heating curve in ISO-834-1. Each of Examples 1-7 and Comparative Examples A-B was respectively clamped to the hole in the furnace door. Thermocouples were respectively placed at a surface of the foam and/or fire barrier that was opposite the experimental heat source for each of Examples 1-7 and Comparative Examples A-B to record temperatures and determine the fire resistance.

For Examples 1-4 and Example 7 the barrier layer was located behind the foam material, relative to the experimental heat source; for experimental purposes Examples 1-4 and Example 7 did not include a second facing. For Examples 5-6 the barrier layer was located in front of the foam material, relative to the experimental heat source; for experimental purposes Examples 5-6 did not include a second facing.

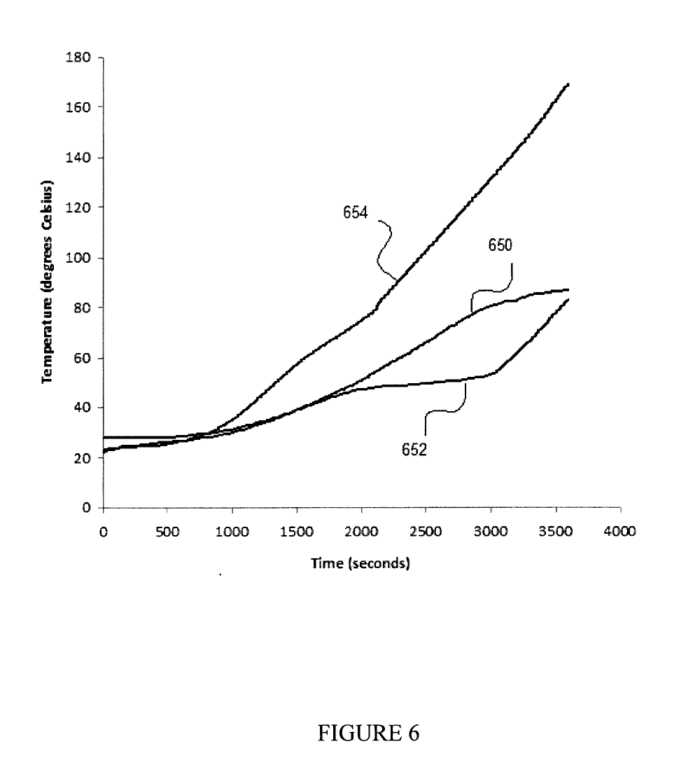

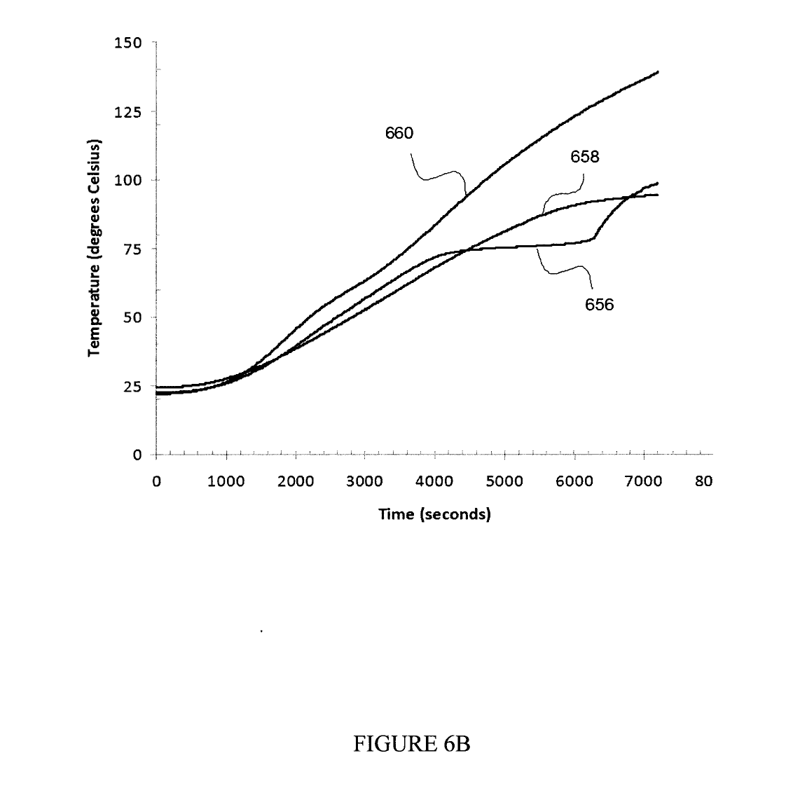

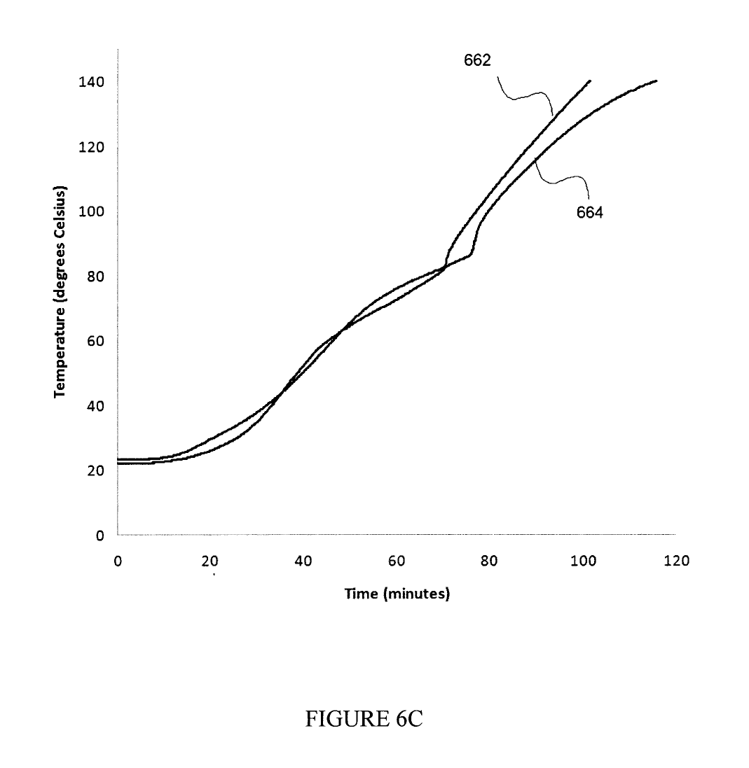

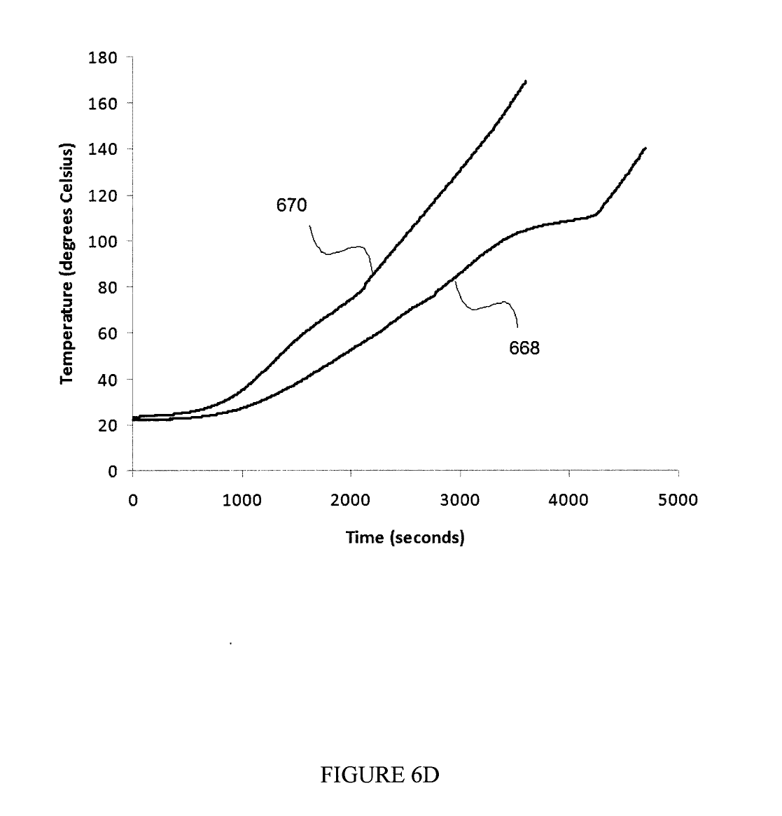

FIG. 6A illustrates experimental temperature versus time data. Plot 650 represents data obtained for Example 1; plot 652 represents data obtained for Example 2; and plot 654 represents data obtained for Comparative Example A. The data of FIG. 6A shows that the temperatures of the surfaces of the foam and/or barrier layer that was opposite the experimental heat source for each of Examples 1-2 remained lower as the experiment progressed, e.g., after a time of approximately 850 seconds, compared to the temperature of the surface of the foam and/or barrier layer that was opposite the experimental heat source for Comparative Example A. In particular, the temperatures of the surfaces of the foam that was opposite the experimental heat source for each of Examples 1-2 remained below 140° C. for at least a 60 minute time interval. In contrast to Examples 1-2, the data of FIG. 6A shows that the temperature of the surface of the foam that was opposite the experimental heat source for Comparative Example A reached 170° C. during the 60 minute time interval. The data of FIG. 6A shows that Examples 1-2 each have an improved fire resistance as compared to Comparative Example A.

FIG. 6B illustrates experimental temperature versus time data. Plot 656 represents data obtained for Example 3; plot 658 represents data obtained for Example 4; and plot 660 represents data obtained for Comparative Example B. The data of FIG. 6B shows that the temperatures of the surfaces of the foam and/or barrier layer that was opposite the experimental heat source for each of Examples 3-4 remained lower as the experiment progressed, e.g., after a time of approximately 1300 seconds, compared to the temperature of the surface of the foam that was opposite the experimental heat source for Comparative Example B. The data of FIG. 6B shows that Examples 3-4 each have an improved fire resistance as compared to Comparative Example B.

FIG. 6C illustrates experimental temperature versus time data. Plot 662 represents data obtained for Example 5; and plot 664 represents data obtained for Example 6. The data of FIG. 6C shows that the temperatures of the surfaces of the foam and/or barrier layer that was opposite the experimental heat source for each of Examples 5-6 remained below 140° C. for at least a 60 minute time interval. The data of FIG. 6C shows that Examples 5-6 each have a fire resistance that exceeds a fire resistance failure mechanism as described herein.

FIG. 6D illustrates experimental temperature versus time data. Plot 668 represents data obtained for Example 7; and plot 670 represents data obtained for Comparative Example C. The data of FIG. 6D shows that the temperatures of the surface of the foam that was opposite the experimental heat source for Example 7 remained lower as the experiment progressed, e.g., after a time of approximately 475 seconds, compared to the temperature of the surface of the foam and/or barrier layer that was opposite the experimental heat source for Comparative Example C. The data of FIG. 6D shows that Example 7 has an improved fire resistance as compared to Comparative Example C.

1. A fire resistant composite structure comprising:
a foam material located between a first facing and a second facing; and
a barrier layer on the foam material, wherein the barrier layer includes an adhesive material and a heat absorption material, wherein the heat absorption material has a melting point of 40° C. to 140° C. and is 15 weight percent to 99 weight percent of the barrier layer.

2. The structure of claim 1, wherein the heat absorption material is selected from the group consisting of a hydrated salt, a polyol, a paraffin, high density polyethylene, and combinations thereof.

3. The structure of claim 1, wherein the heat absorption material is the hydrated salt selected from the group consisting of potassium fluoride dihydrate, potassium acetate hydrate, potassium phosphate heptahydrate, zinc nitrate tetrahydrate, calcium nitrate tetrahydrate, disodium phosphate heptahydrate, sodium thiosulfate pentahydrate, zinc nitrate dihydrate, sodium hydroxide monohydrate, sodium acetate trihydrate, cadmium nitrate tetrahydrate, ferric nitrate hexahydrate, sodium hydroxide, sodium tetraborate decahydrate, trisodium phosphate dodecahydrate, sodium pyrophosphate decahydrate, barium hydroxide octahydrate, aluminum potassium sulfate dodecahydrate, aluminum sulfate octadecahydrate, magnesium nitrate hexahydrate, ammonium aluminum sulfate hexahydrate, sodium sulfide hydrate, calcium bromide tetrahydrate, aluminum sulfate hexadecahydrate, magnesium chloride hexahydrate, aluminum nitrate nonahydrate, lithium acetate dihydrate, strontium hydroxide octahydrate, lithium chloride hydrate, aluminum hydroxide hydrate, calcium sulfate hydrate, and combinations thereof.

4. The structure of claim 1, wherein the barrier layer includes a hollow silicate material that is from 1 weight percent 50 weight percent of the barrier layer.

5. The structure of claim 1, wherein the foam material is a thermoset foam.

6. The structure of claim 5, wherein the thermoset foam is a polyisocyanurate foam or a polyurethane foam.

7. The structure of claim 1, wherein the adhesive material is a thermoset adhesive and is 1 weight percent to 85 weight percent of the barrier layer.

8. The structure of claim 1, wherein the foam material has a thickness of 40 millimeters to 300 millimeters.

9. The structure of claim 1, wherein the barrier layer has a thickness of 2 millimeters to 100 millimeters.

10. The structure of claim 1, wherein the first facing is configured to face a heat source and the barrier layer is adjacent the second facing.

11. The structure of claim 1, wherein the first facing is configured to face a heat source and the barrier layer is adjacent the first facing.

12. The structure of claim 1, further including a second barrier layer on the foam material and adjacent the first facing, wherein the second barrier layer includes a second adhesive material and a second heat absorption material, wherein the second heat absorption material has a melting point of 40° C. to 140° C. and is 15 weight percent to 99 weight percent of the second barrier layer.

13. The structure of claim 1, wherein the heat absorption material has a reflective coating.

14. The structure of claim 13, wherein the reflective coating includes a metal.

15-20. (canceled)
